(19) United States
(12) Patent Application Publication
(10) Pub. No.: US 2005/0244558 A1
(43) Pub. Date: Nov. 3, 2005

(54) Method for preserving peeled whole onions

(76) Inventor: Richard C. Shearer, Royal City, WA (US)

Correspondence Address: John Remon Wenzel, P.O. Box 15035, Crystal City Station, Arlington, VA, 22215-0035, US

(21) Appl. No.: 11/014,958

(22) Filed: Dec. 20, 2004

Related U.S. Application Data
(60) Provisional application No. 60/530,241, filed on Dec. 18, 2003.

(51) Int. Cl. A23P 1/00

(52) U.S. Cl. 426/482

(57) ABSTRACT

The method for preserving peeled whole onions of the present invention involves removing the roots of an onion, peeling its outside papery layers to expose its fleshy layer, and packaging the onion for later use. The basal plate and at least a portion of the neck of the onion must be left intact. Once the papery layers of the onion are removed, the unpenetrated fleshy layer of the onion is exposed. The neck, the basal plate, and the unpenetrated fleshy layer of the onion serve as a protective barrier for the onion so that the peeled onion is still protected from mold, bacteria, and other undesirable elements which may accelerate decay within the packaging. The method of the present invention, thereby serves to increase the shelf life of peeled whole onions and minimize or eliminate growth of mold or bacteria in the onions.

### CROSS-REFERENCE TO RELATED APPLICATION

This application claims the benefit of U.S. Provisional Patent Application Ser. No. 60/530,241, filed Dec. 18, 2003.

### BACKGROUND OF THE INVENTION

1. Field of the Invention

The present invention relates to a method for preserving peeled whole onions, and particularly, to a method for preserving peeled whole onions in packaging.

2. Description of the Related Art

There is a need to provide consumers with fresh whole onions which are peeled in advance, as today's consumers prefer to purchase onions which are ready for cooking or grilling. However, onions, like most vegetables, undergo deterioration of taste and appearance when the skin is removed. Current methods of peeling onions prior to packaging require the complete removal of the onions' necks and cores, which make them particularly susceptible to mold and decay.

Efforts have been made in the past to prolong the time that peeled onions retain their fresh taste and appearance. One method is canning, where the vegetables are sterilized by heat processing and stored in a sealed can. Pickling is another widely used preservation technique. In pickling, the vegetables are immersed in an aqueous pickling medium, which generally contains a high concentration of salt. These methods, however, have failed to satisfactorily preserve the taste and texture of the onions. Another method of preserving peeled onions is immersing them in water until they are needed. However, as the water itself may collect bacteria, this method leaves the onions vulnerable to bacterial infection. Onions are often peeled, cored, and refrigerated for storage; however, this method is expensive and not practical at the wholesale level. A method of preserving onions which extends the shelf life of the onions, protects the onions from mold and bacterial decay, and allows the onions to be stored and displayed in warm environments is desirable.

U.S. Pat. No. 6,139,890, issued Oct. 31, 2000 to J. Simpukas, discloses a method for extending the shelf life of vegetables. The method includes the steps of treating the vegetables with an aqueous solution containing a carboxylic acid and a carboxylic acid salt and then rinsing in order to remove the acid and the salt. The treating and rinsing steps remove bacterial contamination from the treated surfaces, without adversely affecting the organoleptic properties of the fruits and vegetables.

U.S. Pat. No. 5,945,146, issued Aug. 31, 1999 to J. R. Twinam, discloses a fresh vegetable product having long shelf life. The vegetable product includes a fresh vegetable which is cleaned and, if desired, subdivided, and contacted with a chemical mixture of the invention. The chemical mixture may include sodium acid pyrophosphate, calcium chloride, citric acid, potassium sorbate, and optionally, L-ascorbic acid.

Other patents relating to methods of peeling and/or preserving onions include U.K. Patent No. 821,315, published Oct. 3, 1955 (improved method and means for trimming vegetable bulbs, such as onions); U.S. Pat. No. 4,889,046, issued Dec. 26, 1989 to A. Cornellisen (device for peeling onions or other bulbous or tuberous plants); U.S. Pat. No. 5,461,971, issued Oct. 31, 1995 to C. B. Brooks (onion peeling device); U.S. Pat. No. 5,476,037, issued Dec. 19, 1995 to T. Nagaoka (bulbar skin removing apparatus); U.S. Pat. No. 4,602,559, issued Jul. 29, 1986 to S. Suzuki et al. (peeling machine for onions that cuts both ends of onions); U.S. Pat. No. 4,545,297, issued Oct. 8, 1985 to R. Ihlow (onion peeling device); U.S. Pat. No. 4,476,778, issued Oct. 16, 1984 to M. R. Clyma (onion peeling where top and bottom of onion are trimmed); U.S. Pat. No. 4,450,762, issued May 29, 1984 to T. P. Lustig (onion peeling means); U.S. Pat. No. 4,068,011, issued Jan. 10, 1978 to G. R. Green (method of peeling onions by scalding and cutting); U.S. Pat. No. 3,696,848, issued Oct. 10, 1972 to E. P. Mellon (method and apparatus for removing skin from onions or like vegetables); U.S. Pat. No. 3,122,189, issued Feb. 25, 1964 to H. M. Edde (onion top and root trimmer); U.S. Pat. No. 3,057,385, issued Oct. 9, 1962 to C. Kuilman (onion peeling machine); U.S. Pat. No. 1,984,237, issued Dec. 11, 1934 to L. C. Southan (apparatus for removing skins from onions); and U.S. patent application No. 2002/0164406 published Nov. 7, 2002 and applied for by Mendez (a method for preserving fresh cut flowers, fresh fruits and vegetables without the use of refrigeration).

None of the above inventions and patents, taken either singly or in combination, is seen to describe the instant invention as claimed. Thus a method for preserving peeled whole onions solving the aforementioned problems is desired.

### SUMMARY OF THE INVENTION

The method for preserving peeled whole onions of the present invention involves removing the roots of an onion, peeling its outside papery layers to expose its fleshy layer, and packaging the onion for later use. The basal plate and at least a portion of the neck of the onion must be left intact. Once the papery layers of the onion are removed, the unpenetrated fleshy layer of the onion is exposed. The neck, the basal plate, and the unpenetrated fleshy layer of the onion serve as a protective barrier for the onion so that the peeled onion is still protected from mold, bacteria, and other undesirable elements which may accelerate decay within the packaging. The method of the present invention thereby serves to increase the shelf life of peeled whole onions and minimize or eliminate growth of mold or bacteria in the onions.

Accordingly, it is a principal object of the invention to provide a method for preserving peeled whole onions.

It is another object of the invention to provide a method for preserving peeled whole onions which extends the shelf life of the onions in packaging.

It is a further object of the invention to provide a method for preserving peeled whole onions which does not require the addition of preservatives or water.

It is an object of the invention to provide improved elements and arrangements thereof for the purposes described which is inexpensive, dependable and fully effective in accomplishing its intended purposes.

These and other objects of the present invention will become readily apparent upon further review of the following specification.

### DETAILED DESCRIPTION OF THE PREFERRED EMBODIMENT

The present invention relates to a method for preserving peeled whole onions. The method of preserving peeled whole onions includes the steps of removing the roots of an onion, peeling its outside papery layers to expose its unpenetrated fleshy layer, and storing and/or packaging the onion for later use.

Although the onion may be peeled, the basal plate and at least a portion of the neck must remain on the onion. Additionally, the fleshy layer of the onion must be left intact. Cutting off the neck or basal plate, or otherwise piercing into the fleshy layer of the peeled onion results in openings or surface breaks in the onion's fleshy layer which make the onion susceptible to mold, bacterial growth, and other forms of decay. The neck, basal plate, and intact fleshy layer of the onion provide a physical barrier which protects the onion from penetration of such undesirable elements. Consequently, the addition of water or preservatives is not necessary to preserve the onions in packaging.

Any type and size of onion may be preserved by the present method, including red, yellow or white onions ranging from pre-pack (small) to super colossal (large) sizes. The onions may be dried or cured before the roots are removed, and before peeling the outer skin. The onions may be peeled by hand or by machine so long as only the papery layers of the onion and the roots are removed. While the onion neck may not be removed entirely, it may be trimmed insofar as the onion's fleshy layer is not exposed or penetrated as a result.

The onions may be stored and/or packaged in any suitable manner, including, but not limited to, packaging in bulk bins, boxes, trays, clamshells, on pallets, or in bags.

It is to be understood that the present invention is not limited to the embodiment described above, but encompasses any and all embodiments within the scope of the following claims.

1. A method for preserving peeled whole onions, comprising the steps of:
(a) removing the roots of an onion;
(b) peeling the onion's outside papery layers to expose the onion's fleshy layer; and
(c) storing the onion for later use.

2. The method for preserving peeled whole onions according to claim 1, wherein steps (a) and (b) leave the neck of the onion intact.

3. The method for preserving peeled whole onions according to claim 1, wherein steps (a) and (b) leave the neck and the basal plate of the onion intact.

4. The method for preserving peeled whole onions according to claim 1, wherein steps (a) and (b) leave the fleshy layer of the onion intact.

5. The method for preserving peeled whole onions according to claim 1, further comprising the step of drying the onion before steps (a) and (b).

6. The method for preserving peeled whole onions according to claim 1, further comprising the step of curing the onion before steps (a) and (b).

7. The method for preserving peeled whole onions according to claim 1, further comprising the step of trimming the onion neck without exposing or penetrating the onion's fleshy layer.

8. The method for preserving peeled whole onions according to claim 1, wherein steps (a) and (b) are performed by hand.

9. The method for preserving peeled whole onions according to claim 1, wherein steps (a) and (b) are performed by machine.

10. The method for preserving peeled whole onions according to claim 1, wherein step (c) further comprises packaging the onions in a container selected from the group consisting of bulk bins, boxes, trays, clamshells, and bags.

11. An onion prepared and stored according to the method of claim 1.

12. A method for preserving peeled whole onions, comprising the steps of:
(a) removing the roots of an onion;
(b) peeling the onion's outside papery layers to expose the onion's fleshy layer; and
(c) storing the onion for later use;
wherein steps (a) through (c) leave the neck, basal plate, core, and fleshy layer of the onion intact.

13. The method for preserving peeled whole onions according to claim 12, further comprising the step of drying the onion before steps (a) and (b).

13. The method for preserving peeled whole onions according to claim 12, further comprising the step of curing the onion before steps (a) and (b).

14. The method for preserving peeled whole onions according to claim 12, further comprising the step of trimming the onion neck without exposing or penetrating the onion's fleshy layer.

15. The method for preserving peeled whole onions according to claim 12, wherein the onion is selected from the group consisting of a white onion, a red onion, and a yellow onion.

17. The method for preserving peeled whole onions according to claim 12, wherein steps (a) and (b) are performed by hand.

18. The method for preserving peeled whole onions according to claim 12, wherein steps (a) and (b) are performed by machine.

19. The method for preserving peeled whole onions according to claim 12, wherein step (c) further comprises packaging the onions in a container selected from the group consisting of bulk bins, boxes, trays, clamshells, and bags.

20. An onion prepared and stored according to the method of claim 12.
